(19) United States
(12) Patent Application Publication
(10) Pub. No.: US 2021/0153688 A1
(43) Pub. Date: May 27, 2021

(54) CONTROL METHOD OF SMART FOOD PREPARATION DEVICE AND ORDER METHOD OF FOOD

(71) Applicant: AIONE LIFESTYLE STUDIOS INC., Tainan City (TW)

(72) Inventors: TUNG-LIANG LI, TAINAN CITY (TW); CHIA-CHE LI, TAINAN CITY (TW); CHIA-CHIEN LI, TAINAN CITY (TW); CHIA-YING LI, TAINAN CITY (TW); HSIN-HUA LI, TAINAN CITY (TW); CHIA-YEH LI, TAINAN CITY (TW)

(21) Appl. No.: 16/698,146

(22) Filed: Nov. 27, 2019

(51) Int. Cl. A47J 36/32; A47J 43/07; A47J 44/02

(52) U.S. Cl. CPC A47J 36/321; A47J 44/02; A47J 43/07

(57) ABSTRACT

A control method of a smart food preparation device includes: (a) providing a user terminal device displaying a device connection key; (b) clicking the device connection key to connect a smart food preparation device and open a food preparation control page, the smart food preparation device being configured to prepare a food, and the food preparation control page having a switch control key, a mode key and a parameter key; (c) clicking the mode key and the parameter key respectively to set a food preparation mode and food preparation parameters respectively; and (d) clicking the switch control key to start the smart food preparation device to prepare the food according to the food preparation mode and the food preparation parameters.

### BACKGROUND

### 1. Field of the Disclosure

The present disclosure relates to a control method and an order method, and to a control method of a smart food preparation device and an order method of food.

### 2. Description of the Related Art

Conventional food makers generally refer to recipes before food preparation. After readying the food ingredients and putting the food ingredients into a food preparation device, the food preparation device is subjected to on-site real-machine setting operation, and the food ingredients are processed after the relevant preparation settings are completed. However, the conventional food makers often take a long time to flip through the paper recipes to find the recipes they need, and it takes a long time to purchase the ingredients. In addition, the food makers must perform real-machine setting operations on the site of the food preparation device, which also causes great inconvenience to the food makers.

### SUMMARY

In some embodiments, a control method of a smart food preparation device includes: (a) providing a user terminal device displaying a device connection key; (b) clicking the device connection key to connect a smart food preparation device and open a food preparation control page, the smart food preparation device being configured to prepare a food, and the food preparation control page having a switch control key, a mode key and a parameter key; (c) clicking the mode key and the parameter key respectively to set a food preparation mode and food preparation parameters respectively; and (d) clicking the switch control key to start the smart food preparation device to prepare the food according to the food preparation mode and the food preparation parameters.

In some embodiments, a control method of a smart food preparation device includes: (a) providing a user terminal device displaying a digital recipe data, wherein a function key of one-key chef is disposed in the digital recipe data; and (b) clicking the function key of one-key chef to start a smart food preparation device to prepare a food.

In some embodiments, an order method of food includes: (a) clicking a food preparation teaching video, wherein a food order key is disposed on the food preparation teaching video; (b) clicking the food order key to open a food ordering page; and (c) filling the quantity of food and a delivery information thereof in the food ordering page to complete the ordering of food.

### BRIEF DESCRIPTION OF THE DRAWINGS

Aspects of some embodiments of the present disclosure are readily understood from the following detailed description when read with the accompanying figures. It is noted that various structures may not be drawn to scale, and dimensions of the various structures may be arbitrarily increased or reduced for clarity of discussion.

FIG. 1 illustrates a flow diagram of a control method of a smart food preparation device according to some embodiments of the present disclosure.

FIG. 2 illustrates a schematic view of a user terminal device of a control method of a smart food preparation device according to some embodiments of the present disclosure.

FIG. 3 illustrates a schematic view of a user terminal device displaying a food preparation control page of a control method of a smart food preparation device according to some embodiments of the present disclosure.

FIG. 4 illustrates a schematic view of a user terminal device displaying a mode selection page of a control method of a smart food preparation device according to some embodiments of the present disclosure.

FIG. 5 illustrates a schematic view of a user terminal device displaying a diary content page of a control method of a smart food preparation device according to some embodiments of the present disclosure.

FIG. 6 illustrates a schematic view of a user terminal device displaying a plurality of digital recipe options of a control method of a smart food preparation device according to some embodiments of the present disclosure.

FIG. 7 illustrates a schematic view of a user terminal device displaying a digital recipe data of a control method of a smart food preparation device according to some embodiments of the present disclosure.

FIG. 8 illustrates a flow diagram of an order method of food according to some embodiments of the present disclosure.

FIG. 9 illustrates a schematic view of a user terminal device displaying a food preparation teaching video of an order method of food according to some embodiments of the present disclosure.

FIG. 10 illustrates a schematic view of a user terminal device displaying a food ordering page of an order method of food according to some embodiments of the present disclosure.

FIG. 11 illustrates a schematic view of a user terminal device displaying a plurality of stores of a control method of a smart food preparation device according to some embodiments of the present disclosure.

FIG. 12 illustrates a schematic view of a user terminal device displaying products in a store of a control method of a smart food preparation device according to some embodiments of the present disclosure.

FIG. 13 illustrates a schematic view of a user terminal device displaying a brand and a model of a smart food preparation device of a control method of a smart food preparation device according to some embodiments of the present disclosure.

FIG. 14 illustrates a schematic view of a user terminal device displaying a smart food preparation device having a plurality of device options of a control method of a smart food preparation device according to some embodiments of the present disclosure.

FIG. 15 illustrates a schematic view of a user terminal device displaying a recipe creating page of a control method of a smart food preparation device according to some embodiments of the present disclosure.

### DETAILED DESCRIPTION

Common reference numerals are used throughout the drawings and the detailed description to indicate the same or similar components. Embodiments of the present disclosure will be readily understood from the following detailed description taken in conjunction with the accompanying drawings.

The following disclosure provides many different embodiments, or examples, for implementing different features of the provided subject matter. Specific examples of components and arrangements are described below to explain certain aspects of the present disclosure. These are, of course, merely examples and are not intended to be limiting. For example, the formation of a first feature over or on a second feature in the description that follows may include embodiments in which the first and second features are formed or disposed in direct contact, and may also include embodiments in which additional features may be formed or disposed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

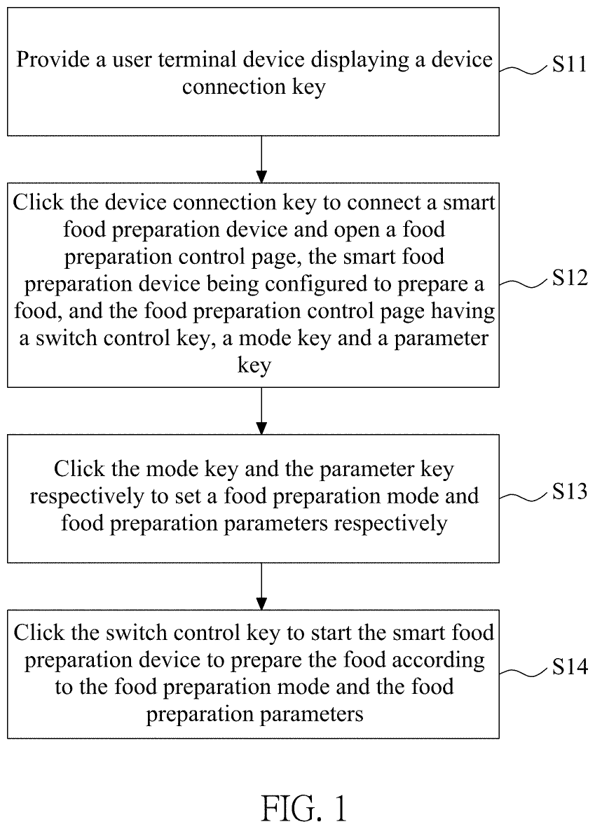

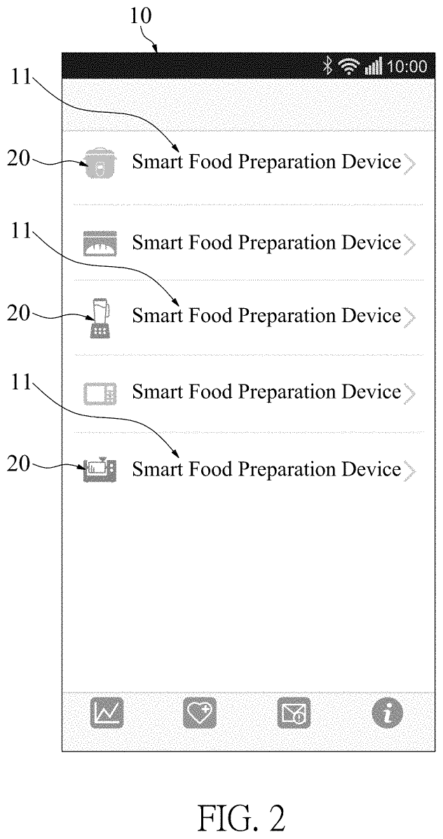

FIG. 1 illustrates a flow diagram of a control method of a smart food preparation device according to some embodiments of the present disclosure. FIG. 2 illustrates a schematic view of a user terminal device of a control method of a smart food preparation device according to some embodiments of the present disclosure. Referring to step S11 of FIG. 1 and FIG. 2, a user terminal device 10 is provided. The user terminal device 10 displays a device connection key 11. In some embodiments, the user terminal device 10 may be a mobile device, and the number of the device connection key 11 may be plural. In some embodiments, the user terminal device 10 may be a computer.

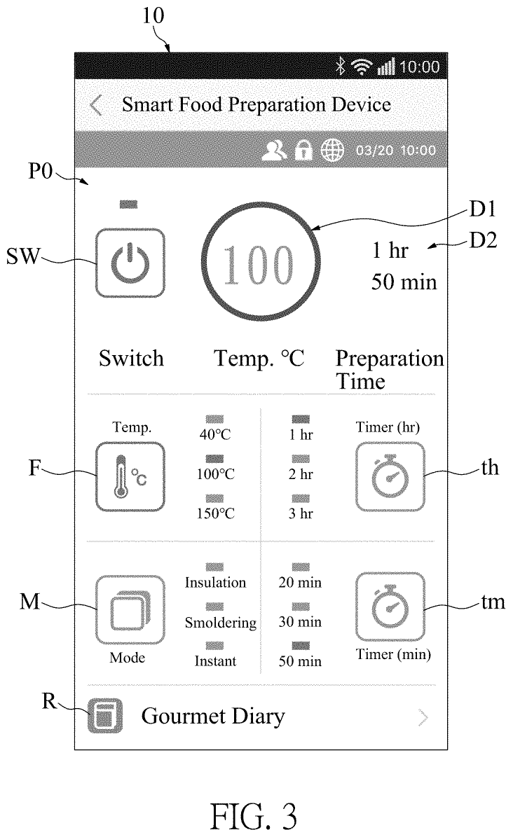

FIG. 3 illustrates a schematic view of a user terminal device displaying a food preparation control page of a control method of a smart food preparation device according to some embodiments of the present disclosure. Referring to step S12 of FIG. 1, FIG. 2 and FIG. 3, the device connection key 11 is clicked to connect a smart food preparation device 20 and open a food preparation control page P0. The smart food preparation device 20 is configured to prepare a food. In some embodiments, the smart food preparation device 20 may be smart conditioning pot, smart bread baking machine, smart fruit and vegetable conditioning machine, smart oven or smart baking machine.

The food preparation control page P0 has a switch control key SW, a mode key M and a parameter key F. The switch control key SW is configured to start and stop the smart food preparation device 20. The mode key M is configured to set a food preparation mode. The parameter key F is configured to set food preparation parameters. The food preparation parameters may include temperature, humidity, time, pressure, weight, volume, air flow, revolution, illumination, dust content, impedance or quantity.

In some embodiments, the food preparation control page P0 further has a first timer key th and a second timer key tm. The first timer key th is configured to set a hour portion of a food preparation time. The second timer key tm is configured to set a minute portion of the food preparation time.

In some embodiments, the food preparation control page P0 may have a parameter displaying area D1 and a time displaying area D2. The parameter displaying area D1 is configured to display the food preparation parameters. The time displaying area D2 is configured to display the food preparation time.

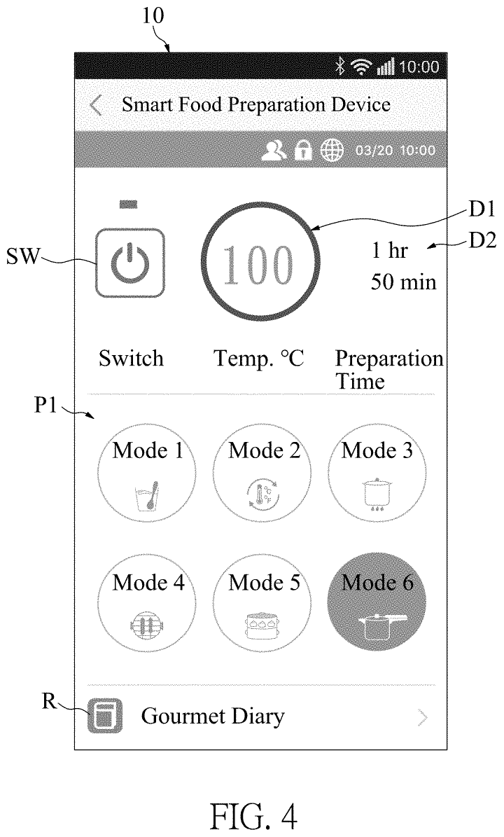

FIG. 4 illustrates a schematic view of a user terminal device displaying a mode selection page of a control method of a smart food preparation device according to some embodiments of the present disclosure. Referring to step S13 of FIG. 1, FIG. 3 and FIG. 4, the mode key M and the parameter key F are clicked respectively to set a food preparation mode and food preparation parameters respectively. In some embodiments, a mode selection page P1 and a function key R of gourmet diary are displayed by clicking the mode key M. The mode selection page P1 at least displays one of the following food preparation modes: yogurt (mode 1), smoldering (mode 2), dry fried (mode 3), dry roast (mode 4), steam (mode 5) and instant (mode 6). In some embodiments, the food preparation mode may be set to one-stage, two-stage or three-stage. Further, the keys of the modes 1 to 6 may be displayed in LED dot matrix manner, and the mode may allow the user to input and be displayed on the food preparation device, or display the name of the stored recipe or food ingredient.

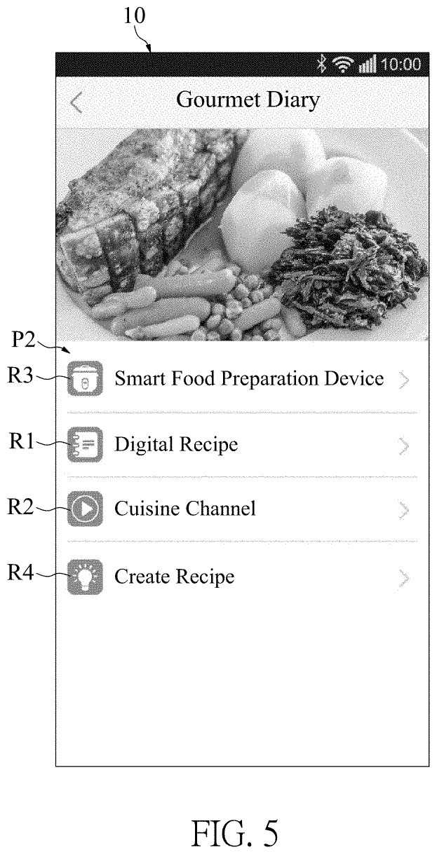

FIG. 5 illustrates a schematic view of a user terminal device displaying a diary content page of a control method of a smart food preparation device according to some embodiments of the present disclosure. Referring to FIG. 4 and FIG. 5, in some embodiments, a diary content page P2 may be displayed by clicking the function key R of gourmet diary. The diary content page P2 includes at least one of the following function keys: digital recipe (R1), cuisine channel (R2), smart food preparation device (R3) and create recipe (R4).

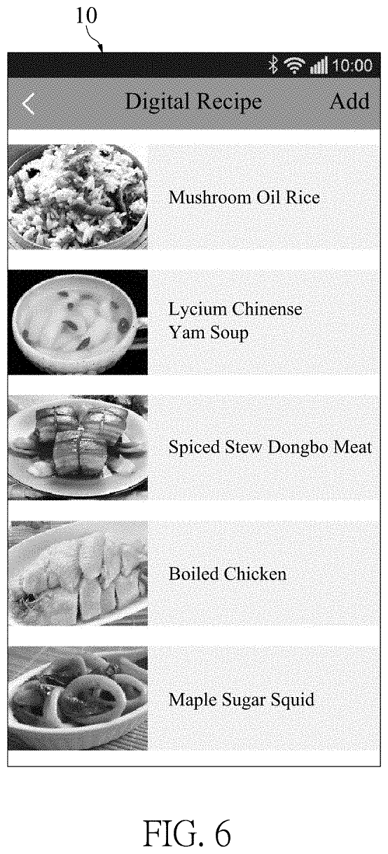

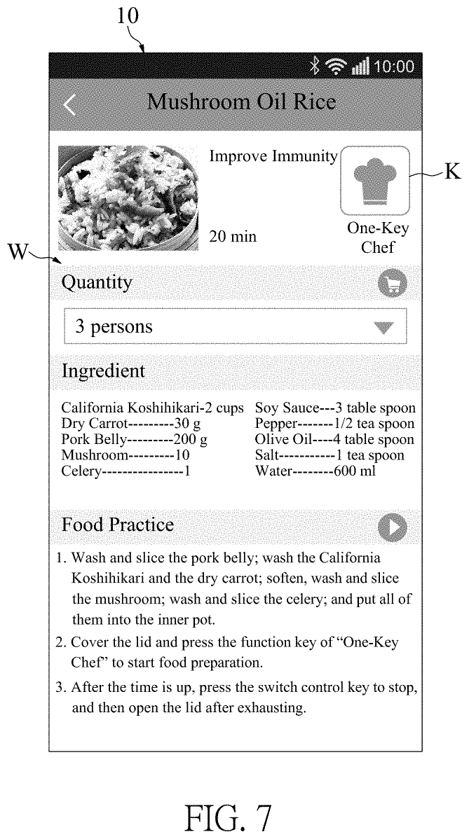

FIG. 6 illustrates a schematic view of a user terminal device displaying a plurality of digital recipe options of a control method of a smart food preparation device according to some embodiments of the present disclosure. FIG. 7 illustrates a schematic view of a user terminal device displaying a digital recipe data of a control method of a smart food preparation device according to some embodiments of the present disclosure. Referring to FIG. 5, FIG. 6 and FIG. 7, a plurality of digital recipe options (FIG. 6) may be displayed by clicking the function key R1 of digital recipe, and a digital recipe data W (FIG. 7) may be displayed after clicking one of the digital recipe options. The digital recipe data W may include recipe name, recipe effect, ingredient and food practice. In some embodiments, a generation manner of the digital recipe data W may be written by users, shared by others or downloaded online.

In some embodiments, a function key K of one-key chef may be disposed in the digital recipe data W to start the smart food preparation device 20 (FIG. 2). The function key K of one-key chef has preset all the preparation settings corresponding to the digital recipe data W. Thus, the food maker does not need to perform the real-machine preparation settings, and only needs to click the function key K of one-key chef to start the smart food preparation device to prepare the food.

In addition, a plurality of cuisine channels and a plurality of food preparation teaching videos may be displayed by clicking the function key R2 of cuisine channel. In some embodiments, the food preparation teaching videos may link to a specific restaurant website to book or order meals. In some embodiments, the food preparation teaching videos may link to a travel channel.

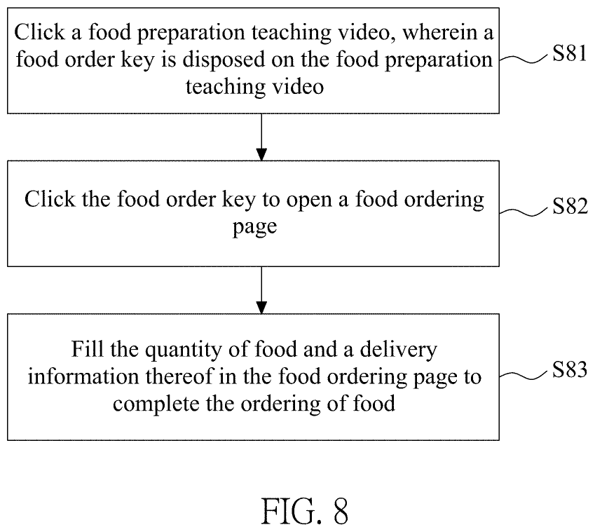

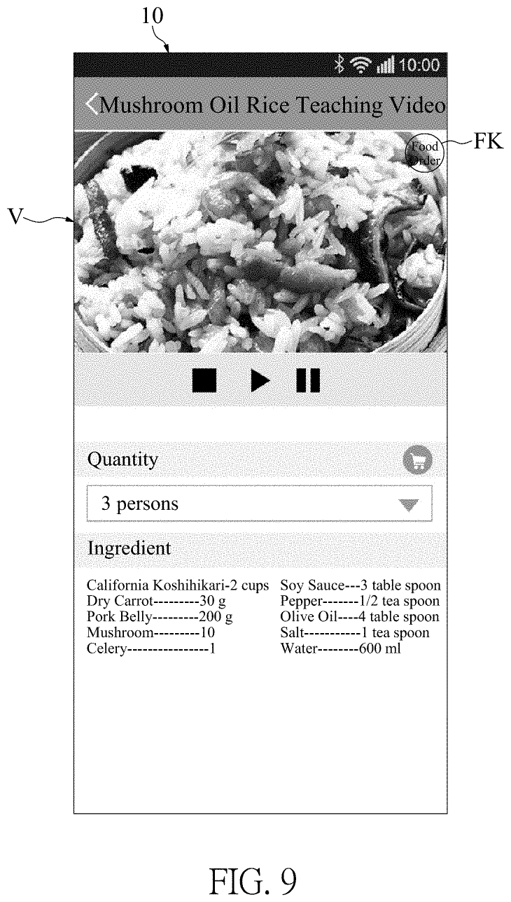

FIG. 8 illustrates a flow diagram of an order method of food according to some embodiments of the present disclosure. FIG. 9 illustrates a schematic view of a user terminal device displaying a food preparation teaching video of an order method of food according to some embodiments of the present disclosure. Referring to step S81 of FIG. 8 and FIG. 9, in order to facilitate the food maker to directly purchase a food ingredient package shown in a food preparation teaching video, and the food maker may click a food preparation teaching video V, and a food order key FK may be disposed on the food preparation teaching video V. In some embodiments, the food preparation teaching video V may be displayed on the user terminal device 10.

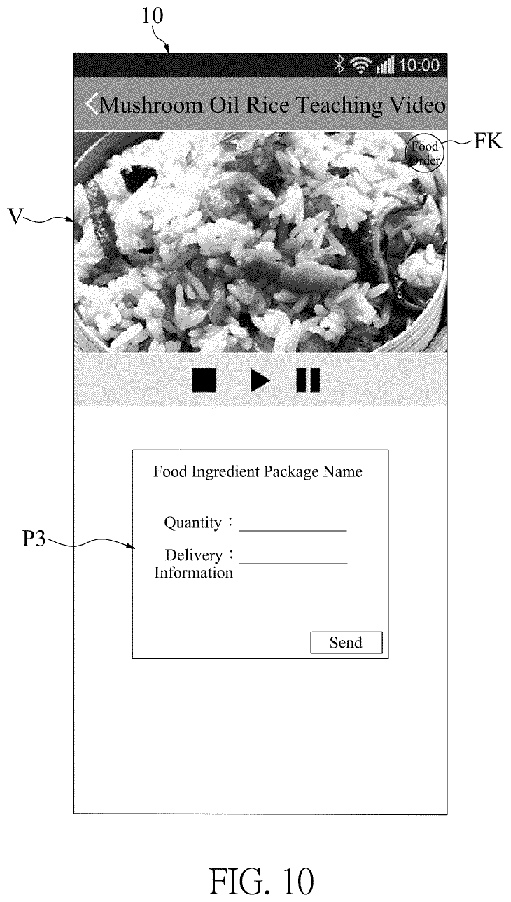

FIG. 10 illustrates a schematic view of a user terminal device displaying a food ordering page of an order method of food according to some embodiments of the present disclosure. Referring to step S82 of FIG. 8, FIG. 9 and FIG. 10, the food order key FK is clicked to open a food ordering page P3.

Referring to step S83 of FIG. 8, FIG. 9 and FIG. 10, the quantity of food and a delivery information thereof are filled in the food ordering page P3 to complete the ordering of food. In some embodiments, the food ordering page P3 may provide different payment methods for purchasers to choose.

The order method of food of the present disclosure may quickly purchase the food shown in the food preparation teaching video V, which greatly saves the purchase time of the food maker.

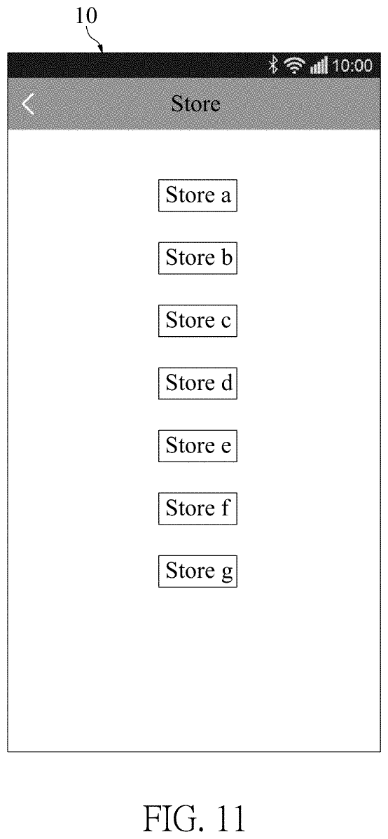

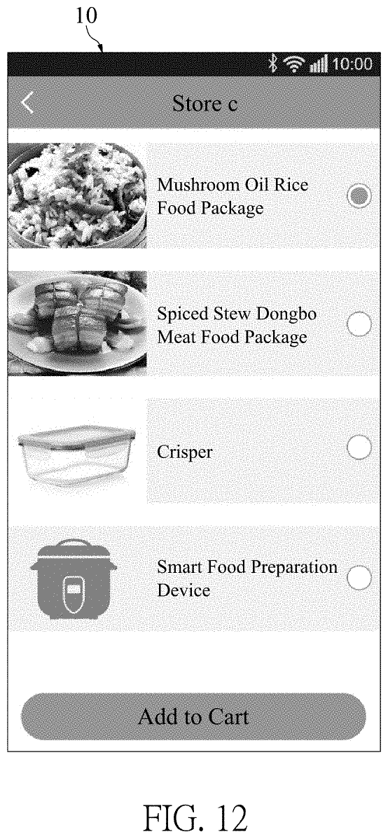

FIG. 11 illustrates a schematic view of a user terminal device displaying a plurality of stores of a control method of a smart food preparation device according to some embodiments of the present disclosure. FIG. 12 illustrates a schematic view of a user terminal device displaying products in a store of a control method of a smart food preparation device according to some embodiments of the present disclosure. Referring to FIG. 11 and FIG. 12, in some embodiments, the user terminal device 10 may display a plurality of stores (e.g., the stores a to g), and the food maker may directly purchase the food ingredient package or other products from the stores a to g.

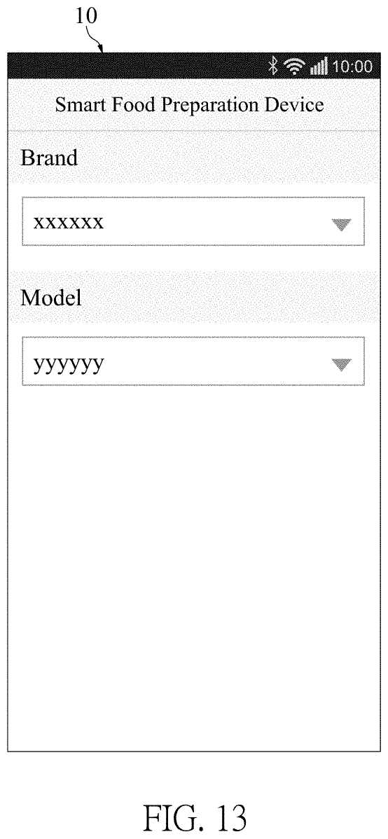

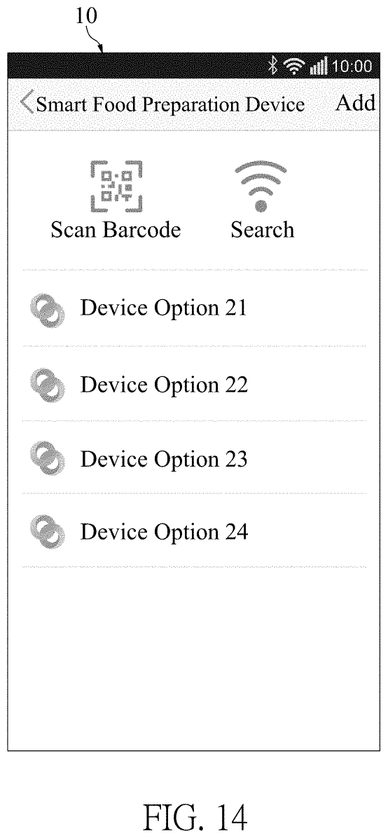

FIG. 13 illustrates a schematic view of a user terminal device displaying a brand and a model of a smart food preparation device of a control method of a smart food preparation device according to some embodiments of the present disclosure. FIG. 14 illustrates a schematic view of a user terminal device displaying a smart food preparation device having a plurality of device options of a control method of a smart food preparation device according to some embodiments of the present disclosure. Referring to FIG. 5, FIG. 13 and FIG. 14, a brand and a model of the smart food preparation device may be displayed by clicking the function key R3 of smart food preparation device. In some embodiments, the smart food preparation device may have one or more device options (e.g., the device options 21 to 24) to enable the food maker to select the applicable device option based on the digital recipe. In some embodiments, the smart food preparation device may add the device option through scanning a barcode or searching, and preferably, the barcode is a quick response code (QR Code). In some embodiments, the quick response code (QR Code) may also be used for operations of device connection, member registration, digital recipes, one-key chef, video content links, website links, food purchase and food ingredient suppliers.

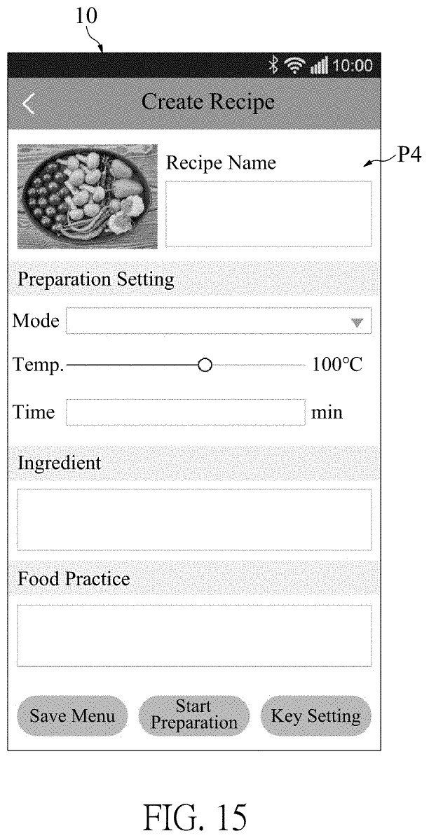

FIG. 15 illustrates a schematic view of a user terminal device displaying a recipe creating page of a control method of a smart food preparation device according to some embodiments of the present disclosure. Referring to FIG. 5 and FIG. 15, a recipe creating page P4 may be displayed by clicking the function key R4 of create recipe. The food maker may write the digital recipe data on the recipe creating page P4, and save the data and start food preparation after the writing is completed.

Referring to step S14 of FIG. 1, FIG. 2 and FIG. 3, the switch control key SW is clicked to start the smart food preparation device 20 to prepare the food according to the food preparation mode and the food preparation parameters.

The control method of the smart food preparation device of the present disclosure may provide the food maker to quickly obtain the required digital recipe, and may remotely control the smart food preparation device through the user terminal device. Thus, the food maker does not need to be in the site of the smart food preparation device, and may still perform the real-machine preparation settings. The smart food preparation device may be started to prepare the food after the relevant preparation settings are completed.

Moreover, the scope of the present application is not intended to be limited to the particular embodiments of the process, machine, manufacture, and composition of matter, means, methods and steps described in the specification. As those skilled in the art will readily appreciate form the present disclosure, processes, machines, manufacture, compositions of matter, means, methods, or steps, presently existing or later to be developed, that perform substantially the same function or achieve substantially the same result as the corresponding embodiments described herein may be utilized in accordance with some embodiments of the present disclosure.

Accordingly, the appended claims are intended to include within their scope such processes, machines, manufacture, and compositions of matter, means, methods or steps. In addition, each claim constitutes a separate embodiment, and the combination of various claims and embodiments are within the scope of the invention.

What is claimed is:

1. A control method of a smart food preparation device, comprising:
(a) providing a user terminal device displaying a device connection key;
(b) clicking the device connection key to connect a smart food preparation device and open a food preparation control page, the smart food preparation device being configured to prepare a food, and the food preparation control page having a switch control key, a mode key and a parameter key;
(c) clicking the mode key and the parameter key respectively to set a food preparation mode and food preparation parameters respectively; and
(d) clicking the switch control key to start the smart food preparation device to prepare the food according to the food preparation mode and the food preparation parameters.

2. The control method of claim 1, wherein the user terminal device is a mobile device or a computer.

3. The control method of claim 1, wherein the smart food preparation device has a plurality of device options, and the smart food preparation device adds the device option through scanning a barcode or searching.

4. The control method of claim 3, wherein the barcode is a quick response code (QR Code).

5. The control method of claim 1, wherein the food preparation control page further has a parameter displaying area to display the food preparation parameters.

6. The control method of claim 1, wherein the food preparation control page further has a first timer key and a second timer key, the first timer key is configured to set a hour portion of a food preparation time, and the second timer key is configured to set a minute portion of the food preparation time.

7. The control method of claim 6, wherein the food preparation control page further has a time displaying area to display the food preparation time.

8. The control method of claim 1, wherein the food preparation parameters includes temperature, humidity, time, pressure, weight, volume, air flow, revolution, illumination, dust content, impedance or quantity.

9. The control method of claim 1, wherein clicking the mode key is to display a mode selection page and a function key of gourmet diary.

10. The control method of claim 9, wherein the mode selection page at least displays one of the following food preparation modes: yogurt, smoldering, dry fried, dry roast, steam and instant.

11. The control method of claim 9, wherein a diary content page is displayed by clicking the function key of gourmet diary, and the diary content page includes at least one of the following function keys: digital recipe, cuisine channel, smart food preparation device and create recipe.

12. The control method of claim 11, wherein a plurality of digital recipe options are displayed by clicking the function key of digital recipe, and a digital recipe data is displayed after clicking one of the digital recipe options.

13. The control method of claim 12, wherein the digital recipe data includes recipe name, recipe effect, ingredient and food practice.

14. The control method of claim 12, wherein a function key of one-key chef is disposed in the digital recipe data to start the smart food preparation device.

15. The control method of claim 12, wherein a generation manner of the digital recipe data is written by users, shared by others or downloaded online.

16. The control method of claim 11, wherein a plurality of cuisine channels and a plurality of food preparation teaching videos are displayed by clicking the function key of cuisine channel.

17. The control method of claim 16, wherein the food preparation teaching videos link to a specific restaurant website to book or order meals.

18. The control method of claim 16, wherein the food preparation teaching videos link to a travel channel.

19. The control method of claim 11, wherein a brand and a model of the smart food preparation device are displayed by clicking the function key of smart food preparation device.

20. The control method of claim 11, wherein a recipe creating page is displayed by clicking the function key of create recipe.

21. A control method of a smart food preparation device, comprising:
(a) providing a user terminal device displaying a digital recipe data, wherein a function key of one-key chef is disposed in the digital recipe data; and
(b) clicking the function key of one-key chef to start a smart food preparation device to prepare a food.

22. An order method of food, comprising:
(a) clicking a food preparation teaching video, wherein a food order key is disposed on the food preparation teaching video;
(b) clicking the food order key to open a food ordering page; and
(c) filling the quantity of food and a delivery information thereof in the food ordering page to complete the ordering of food.
